(19) United States
(12) Patent Application Publication
(10) Pub. No.: US 2023/0288214 A1
(43) Pub. Date: Sep. 14, 2023

(54) VEHICLE NAVIGATION APPARATUS

(71) Applicant: SUBARU CORPORATION, Tokyo (JP)

(72) Inventor: Ryota NAKAMURA, Tokyo (JP)

(21) Appl. No.: 18/168,829

(22) Filed: Feb. 14, 2023

(30) Foreign Application Priority Data
Mar. 8, 2022 (JP) 2022-035598

(51) Int. Cl. G01C 21/34; G01C 21/36; B60W 60/00

(52) U.S. Cl. CPC G01C 21/3453; G01C 21/3667; B60W 60/00; B60W 2556/40

(57) ABSTRACT

A vehicle navigation apparatus includes a position information detector, an information receiver, a candidate route searching unit, a determination unit, a recommended route searching unit, an output unit, and a display. The candidate route searching unit searches navigation map information for candidate routes, based on destination information accepted by the information receiver from a user and vehicle position information acquired by the position information detector. The determination unit make a determination, regarding the candidate routes, on effectiveness of driving assistance control or automatic driving control based on high-precision map information. The recommended route searching unit searches through the candidate routes for a recommended route, based on the determination by the determination unit. The output unit outputs information on the recommended route to a control apparatus. The display displays the recommended route. The determination unit determines a route unlikely to cause abnormality in the control as a route with effectiveness

### CROSS-REFERENCE TO RELATED APPLICATIONS

The present application claims priority from Japanese Patent Application No. 2022-035598 filed on Mar. 8, 2022, the entire contents of which are hereby incorporated by reference.

### BACKGROUND

The disclosure relates to a vehicle navigation apparatus.

Recent years have seen development of, as control using a high-precision map, driving assistance control that assists driving operations of a vehicle, or automatic driving control that automatically controls driving operations of a vehicle.

At present, in automatic driving at level 3 or higher approaching a practical stage, the driving assistance control or the automatic driving control is performed on the basis of the high-precision map, and route display, for example, is performed by using navigation map information in many cases.

A vehicle control apparatus that achieves the automatic driving control is known. The vehicle control apparatus sets a traveling route to a destination on the basis of map information, and controls driving operations of the vehicle along the traveling route on the basis of information acquired by an in-vehicle sensor. Reference is made to Japanese Unexamined Patent Application Publication (JP-A) No. 2019-20782, for example.

### SUMMARY

An aspect of the disclosure provides a vehicle navigation apparatus to be applied to a vehicle. The vehicle navigation apparatus includes a first map storage, a second map storage, a position information detector, an information receiver, a candidate route searching unit, a determination unit, a recommended route searching unit, an output unit, and a display. The first map storage is configured to store navigation map information. The second map storage is configured to store high-precision map information. The position information detector is configured to acquire position information of the vehicle. The information receiver is configured to accept information including destination information from a user of the vehicle.

The candidate route searching unit is configured to perform searching of the navigation map information for one or more candidate routes, on the basis of the destination information and the position information of the vehicle. The determination unit is configured to make a determination as to, regarding the one or more candidate routes retrieved by the searching, effectiveness of driving assistance control or automatic driving control on the basis of the high-precision map information. The recommended route searching unit is configured to perform searching through the one or more candidate routes for a recommended route, on the basis of a result of the determination made by the determination unit. The output unit is configured to output information on the recommended route to a driving assistance control apparatus or an automatic driving control apparatus. The display is configured to display the recommended route. The determination unit is configured to determine a route that is unlikely to cause abnormality in the driving assistance control or the automatic driving control as a route with the effectiveness.

An aspect of the disclosure provides a vehicle navigation apparatus to be applied to a vehicle. The vehicle navigation apparatus includes a first map storage, a second map storage, a position information detector, an information receiver, circuitry, and a display. The first map storage is configured to store navigation map information. The second map storage is configured to store high-precision map information. The position information detector is configured to acquire position information of the vehicle. The information receiver is configured to accept information including destination information from a user of the vehicle. The circuitry is configured to perform searching of the navigation map information for one or more candidate routes, on the basis of the destination information and the position information of the vehicle. The circuitry is configured to make a determination as to, regarding the one or more candidate routes retrieved by the searching, effectiveness of driving assistance control or automatic driving control on the basis of the high-precision map information. The circuitry is configured to perform searching through the one or more candidate routes for a recommended route, on the basis of a result of the determination as to the effectiveness. The circuitry is configured to output information on the recommended route to a driving assistance control apparatus or an automatic driving control apparatus. The display is configured to display the recommended route. The circuitry is configured to determine a route that is unlikely to cause abnormality in the driving assistance control or the automatic driving control as a route with the effectiveness.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a configuration of a vehicle navigation apparatus according to one example embodiment of the disclosure.

FIG. 2 is a diagram illustrating candidate route information in normal route searching according to one example embodiment of the disclosure.

FIG. 3 is a diagram illustrating candidate routes in the normal route searching according to one example embodiment of the disclosure.

FIG. 4 is a flowchart illustrating processing performed in the normal route searching by the vehicle navigation apparatus according to one example embodiment of the disclosure.

FIG. 5 is a diagram illustrating candidate route information in a case where a destination is changed according to one example embodiment of the disclosure.

FIG. 6 is a diagram illustrating candidate routes in the case where the destination is changed according to one example embodiment of the disclosure.

FIG. 7 is a flowchart illustrating processing performed in the case where the destination is changed by the vehicle navigation apparatus according to one example embodiment of the disclosure.

FIG. 8 is a diagram illustrating candidate route information in route re-searching according to one example embodiment of the disclosure.

FIG. 9 is a diagram illustrating candidate routes in the route re-searching according to one example embodiment of the disclosure.

FIG. 10 is a flowchart illustrating processing performed in the route re-searching by the vehicle navigation apparatus according to one example embodiment of the disclosure.

FIG. 11 is a diagram illustrating a configuration of a vehicle navigation apparatus according to one example embodiment of the disclosure.

FIG. 12 is a diagram illustrating candidate route information in a case where traveling information is acquired according to one example embodiment of the disclosure.

FIG. 13 is a diagram illustrating candidate routes in the case where the traveling information is acquired according to one example embodiment of the disclosure.

FIG. 14 is a flowchart illustrating processing performed in the case where the traveling information is acquired by the vehicle navigation apparatus according to one example embodiment of the disclosure.

### DETAILED DESCRIPTION

An apparatus disclosed in JP-A No. 2019-20782 sets a traveling route to a destination on the basis of map information stored in the apparatus, and achieves automatic driving control on the basis of the traveling route and information on the surrounding environment around an own vehicle acquired by an in-vehicle sensor.

An electronic control unit (ECU) mounted in the own vehicle determines whether the map information stored in the apparatus matches with measurement-point information acquired by the in-vehicle sensor. If the ECU does not determine that the map information matches with the measurement-point information while the automatic driving control is being executed, the mode of the automatic driving control is switched on the basis of the result of determination.

On the other hand, a possible measure to achieve automatic driving by using information received by a vehicle navigation apparatus involves setting a destination to the vehicle navigation apparatus, and determining a traveling route along which the automatic driving is to be achieved on the basis of a route generated from a navigation map.

The navigation map, however, takes time and costs when being updated, and is thus updated at a predetermined constant interval.

In other words, the navigation map is updated less frequently than a high-precision map used for automatic driving control. This difference in update frequency results in discrepancies in route information between the navigation map and the high-precision map.

For example, in a case where the vehicle travels on a route inexistent in the route generated from the navigation map, a route displayed on the vehicle navigation apparatus differs from the route on which the vehicle is actually traveling. As a result, the vehicle is displayed as being traveling through points of a route inexistent in the navigation map. This can make an occupant of the own vehicle feel strange or anxious. Such a concern also arises in driving assistance control.

It is desirable to provide a vehicle navigation apparatus that reduces a feeling of strangeness or anxiety of a user, by achieving both route display based on navigation map information and driving assistance control or automatic driving control based on a high-precision map.

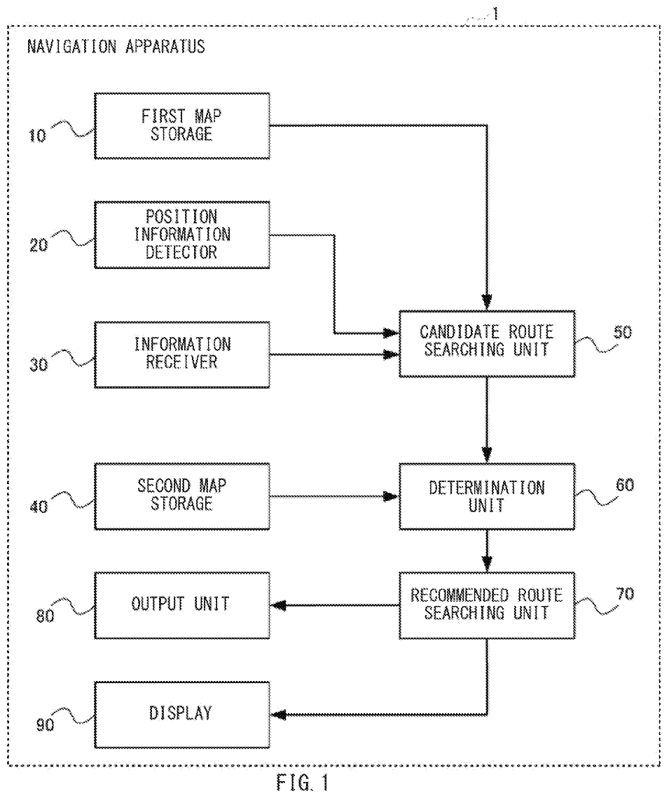

In the following, some example embodiments of the disclosure are described in detail with reference to FIGS. 1 to 14. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### First Example Embodiment

A vehicle navigation apparatus 1 according to a first example embodiment will now be described with reference to FIGS. 1 to 10.

### [Configuration of Vehicle Navigation Apparatus 1]

As illustrated in FIG. 1, the vehicle navigation apparatus 1 according to the example embodiment includes a first map storage 10, a position information detector 20, an information receiver 30, a second map storage 40, a candidate route searching unit 50, a determination unit 60, a recommended route searching unit 70, an output unit 80, and a display 90.

The first map storage 10 stores navigation map information serving as first map information.

In one example, the first map storage 10 may include a hard disk device and a semiconductor memory. The first map storage 10 may store, for example, map information to be used for navigation such as route searching or facility searching.

The navigation map information stored in the first map storage 10 may be read by the candidate route searching unit 50 to be described later.

The position information detector 20 may include, for example, a GPS receiver, an azimuth sensor, and a range sensor. The position information detector 20 may acquire information on the position (e.g., the latitude and longitude) of an own vehicle at a predetermined timing, to thereby acquire position information of the own vehicle.

The position information of the own vehicle acquired by the position information detector may be outputted to the candidate route searching unit 50 to be described later.

The information receiver 30 accepts information including destination information from a user.

Examples of the information receiver 30 may include a touch panel disposed on the front of the vehicle navigation apparatus 1. By receiving a touch operation on the touch panel performed by the user, the information receiver 30 may accept, for example, information to be used for the route searching, including the destination information, waypoint information, a route searching instruction, and a toll road priority instruction.

The second map storage 40 stores high-precision map information serving as second map information.

In one example, the second map storage 40 may include a hard disk device and a semiconductor memory, and may store detailed map information to be used for driving assistance control or automatic driving control.

The high-precision map information stored in the second map storage 40 may be read by the determination unit 60 to be described later.

The candidate route searching unit 50 searches the navigation map information for one or more candidate routes, on the basis of the destination information accepted from the user via the information receiver 30, the position information of the own vehicle received from the position information detector 20, and other supplementary information.

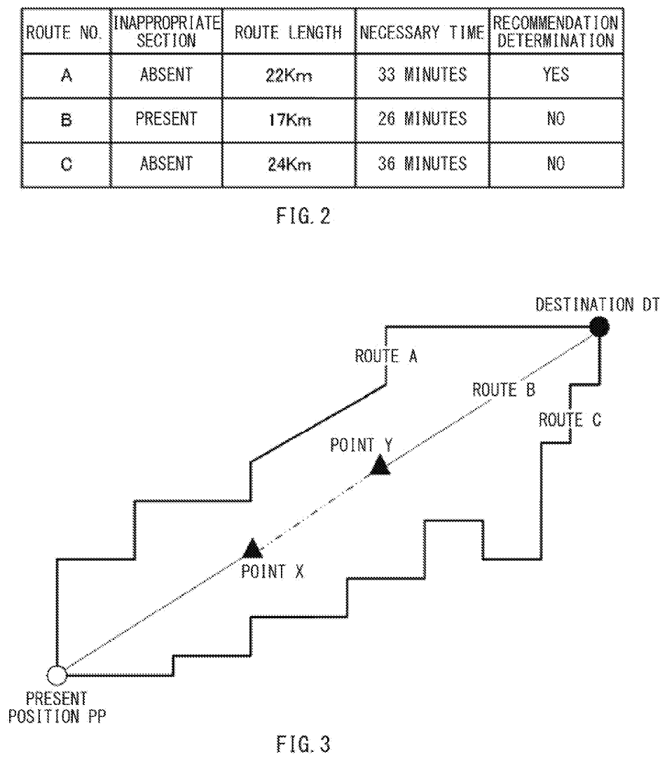

For example, in the example of FIGS. 2 and 3, the candidate route searching unit 50 may retrieve route A, route B, and route C as the candidate routes. Candidate route information thus retrieved by the candidate route searching unit 50 may be outputted to the determination unit 60 to be described later.

Regarding the candidate routes retrieved by the candidate route searching unit 50, the determination unit 60 determines effectiveness of the driving assistance control or the automatic driving control, on the basis of the high-precision map information stored in the second map storage 40.

The determination unit 60 may determine a route that is unlikely to cause abnormality in the driving assistance control or the automatic driving control as a route with effectiveness. For example, in the example of FIGS. 2 and 3, the determination unit 60 may determine whether the candidate routes (route A, route B, and route C) retrieved by the candidate route searching unit 50 are able to secure the effectiveness of the driving assistance control or the automatic driving control, on the basis of the high-precision map information stored in the second map storage 40.

In the example of FIGS. 2 and 3, route B includes, in a section from point X to point Y, a section inappropriate for the driving assistance control or the automatic driving control. The determination unit 60 may therefore determine that the effectiveness of the driving assistance control or the automatic driving control is not securable.

Note that examples of the section inappropriate for the driving assistance control or the automatic driving control may include, regarding the candidate route retrieved by the candidate route searching unit 50, a section in which a predetermined proportion or more of the route is inexistent in the high-precision map, and a section that partly includes a section stored in advance as a route inappropriate for the driving assistance control or the automatic driving control.

In contrast, in the example of FIGS. 2 and 3, route A and route C do not include a section that inhibits the effectiveness of the driving assistance control or the automatic driving control. The determination unit 60 may therefore regard each of the routes as a route that is unlikely to cause abnormality in the driving assistance control or the automatic driving control, and determine that the effectiveness of the driving assistance control or the automatic driving control is securable.

The determination unit 60 may output a determination result as illustrated in FIG. 2 to the recommended route searching unit 70.

The recommended route searching unit 70 searches through the candidate routes retrieved by the candidate route searching unit 50 for a recommended route, on the basis of the determination result obtained by the determination unit 60.

For example, in the example of FIGS. 2 and 3, the recommended route searching unit 70 may exclude route B from the recommended route, on the basis of the determination result obtained by the determination unit 60.

In the example of FIGS. 2 and 3, for route A or route C, the recommended route searching unit 70 may, for example, refer to a route length and a necessary time of each route, and retrieve route A with a shorter route length and a shorter necessary time as the recommended route.

The recommended route searching unit 70 may output information on the recommended route, i.e., recommended route information, to the output unit 80 and the display 90.

The output unit 80 outputs the recommended route information retrieved by the recommended route searching unit 70 to a driving assistance control apparatus or an automatic driving control apparatus. The driving assistance control apparatus or the automatic driving control apparatus may execute the driving assistance control or the automatic driving control, on the basis of the recommended route information received from the output unit 80.

The display 90 may include, for example, a liquid crystal panel. The display 90 may display the recommended route to be viewable by the user or an occupant, on the basis of information on the recommended route (route A) retrieved by the recommended route searching unit 70.

Note that the display 90 may, for example, display the routes of route A and route C including the information illustrated in FIG. 2, on the basis of the determination result obtained by the determination unit 60, and allow the user to determine which route to select.

### [Processing Performed in Normal Route Searching by Vehicle Navigation Apparatus 1]

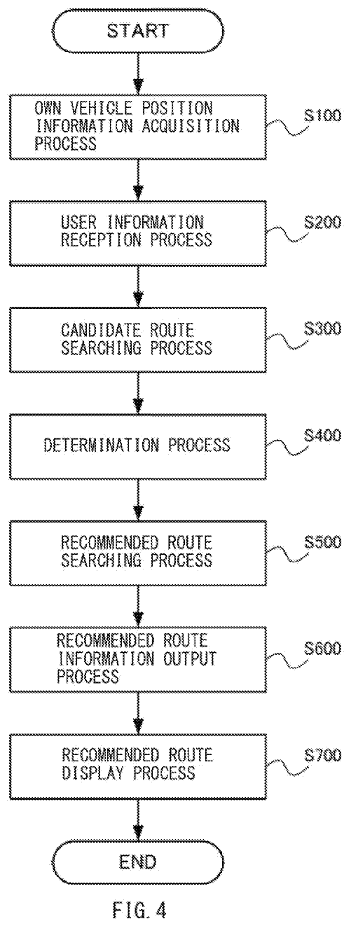

Processing performed in normal route searching by the vehicle navigation apparatus 1 according to the example embodiment will now be described with reference to FIG. 4.

As illustrated in FIG. 4, the position information detector 20 may acquire the position information of the own vehicle (step S100). The position information of the own vehicle acquired by the position information detector 20 may be outputted to the candidate route searching unit 50.

The information receiver 30 may accept information including the destination information from the user (step S200). The accepted information may include, for example, the destination information, the waypoint information, the route searching instruction, and the toll road priority instruction.

The information accepted by the information receiver 30 may be outputted to the candidate route searching unit 50.

The candidate route searching unit 50 may search the navigation map information for one or more candidate routes, on the basis of the destination information accepted from the user via the information receiver 30, the position information of the own vehicle received from the position information detector 20, and other supplementary information (step S300).

The candidate route information thus retrieved by the candidate route searching unit 50 may be outputted to the determination unit 60 to be described later.

Regarding the candidate routes retrieved by the candidate route searching unit 50, the determination unit 60 may determine the effectiveness of the driving assistance control or the automatic driving control, on the basis of the high-precision map information stored in the second map storage 40 (step S400).

In the example of FIGS. 2 and 3, the determination unit 60 may determine route A and route C as routes with effectiveness, and determine route B as a route without effectiveness. The determination unit 60 may output the determination result as illustrated in FIG. 2 to the recommended route searching unit 70.

The recommended route searching unit 70 may search through the candidate routes retrieved by the candidate route searching unit 50 for a recommended route, on the basis of the determination result obtained by the determination unit 60 (step S500).

In the example of FIGS. 2 and 3, for route A or route C, excluding route B, the recommended route searching unit 70 may, for example, refer to the route length and the necessary time of each route, and retrieve route A with a shorter route length and a shorter necessary time as the recommended route.

The recommended route searching unit 70 may output the recommended route information to the output unit 80 and the display 90.

The output unit 80 may output the recommended route information retrieved by the recommended route searching unit 70 to the driving assistance control apparatus or the automatic driving control apparatus (step S600).

The driving assistance control apparatus or the automatic driving control apparatus may execute the driving assistance control or the automatic driving control, on the basis of the recommended route information received from the output unit 80.

The display 90 may display the recommended route to be viewable by the user or occupant, on the basis of the recommended route information retrieved by the recommended route searching unit 70 (step S700).

For example, in the example of FIG. 3, the display 90 may display the route of route A received from the recommended route searching unit 70 to be viewable by the user or occupant.

[Processing Performed in Re-searching upon Destination Change by Vehicle Navigation Apparatus 1]

Processing performed in re-searching upon a destination change by the vehicle navigation apparatus 1 according to the example embodiment will now be described with reference to FIGS. 5 to 7.

As illustrated in FIG. 7, the position information detector 20 may acquire the position information of the own vehicle (step S100). The position information of the own vehicle acquired by the position information detector 20 may be outputted to the candidate route searching unit 50.

The information receiver 30 may accept information including new destination information from the user (step S210). The information accepted by the information receiver 30 may be outputted to the candidate route searching unit 50.

The candidate route searching unit 50 may determine whether a change request for the destination, i.e., a destination change request, has been made, on the basis of the information accepted from the user via the information receiver 30 (step 800).

If the candidate route searching unit 50 determines that a destination change request has not been made, on the basis of the information accepted from the user via the information receiver 30 (step S800: “NO”), the candidate route searching unit 50 may cause the processing to return to step S800 and be put on standby.

If the candidate route searching unit 50 determines that a destination change request has been made, on the basis of the information accepted from the user via the information receiver 30 (step S800: “YES”), the candidate route searching unit 50 may re-search the navigation map information for one or more candidate routes on the basis of the new destination information accepted from the user via the information receiver 30, the position information of the own vehicle received from the position information detector 20, and other supplementary information (step S310).

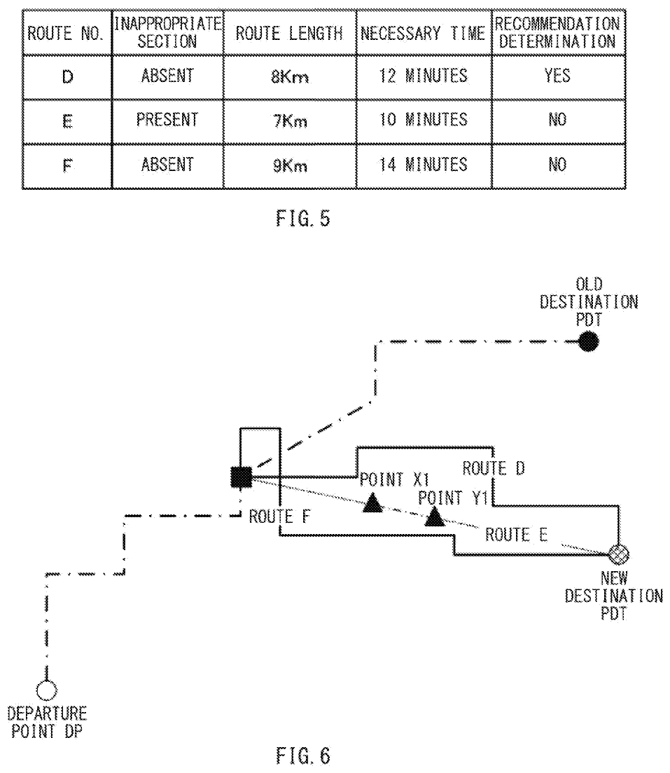

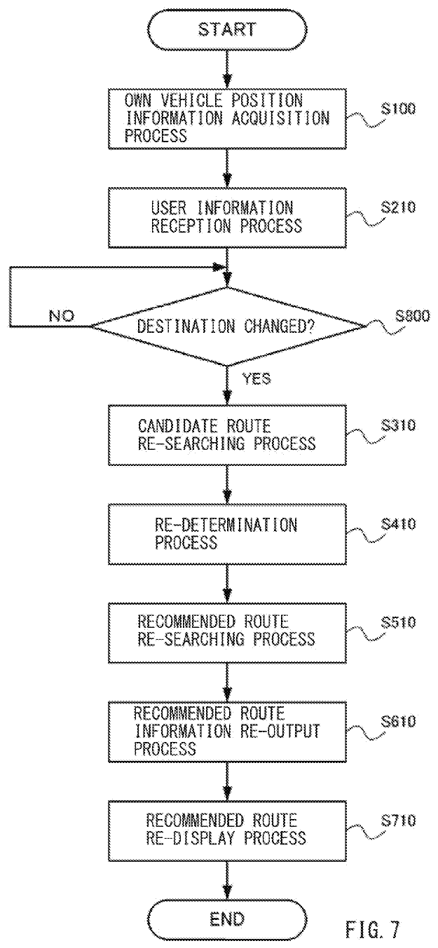

For example, in the example of FIGS. 5 and 6, the candidate route searching unit 50 may re-retrieve route D, route E, and route F as the candidate routes.

The candidate route information thus re-retrieved by the candidate route searching unit 50 may be outputted to the determination unit 60 to be described later.

Regarding the candidate routes re-retrieved by the candidate route searching unit 50, the determination unit 60 may re-determine the effectiveness of the driving assistance control or the automatic driving control, on the basis of the high-precision map information stored in the second map storage 40 (step S410).

For example, in the example of FIGS. 5 and 6, the determination unit 60 may determine whether the candidate routes (route D, route E, and route F) re-retrieved by the candidate route searching unit 50 are able to secure the effectiveness of the driving assistance control or the automatic driving control, on the basis of the high-precision map information stored in the second map storage 40.

Route E includes, in a section from point X1 to point Y1, a section inappropriate for the driving assistance control or the automatic driving control. The determination unit 60 may therefore determine that the effectiveness of the driving assistance control or the automatic driving control is not securable.

In contrast, route D and route F do not include a section that inhibits the effectiveness of the driving assistance control or the automatic driving control. The determination unit 60 may therefore determine that the effectiveness of the driving assistance control or the automatic driving control is securable.

The determination unit 60 may output a determination result as illustrated in FIG. 5 to the recommended route searching unit 70.

The recommended route searching unit 70 may re-search through the candidate routes re-retrieved by the candidate route searching unit 50 for a recommended route, on the basis of the determination result obtained by the determination unit 60 (step S510).

For example, in the example of FIGS. 5 and 6, the recommended route searching unit 70 may exclude route E from the recommended route, on the basis of the determination result obtained by the determination unit 60.

In contrast, for route D or route F, the recommended route searching unit 70 may, for example, refer to the route length and the necessary time of each route, and retrieve route D with a shorter route length and a shorter necessary time as the recommended route.

The recommended route searching unit 70 may output the recommended route information to the output unit 80 and the display 90.

The output unit 80 may output the recommended route information re-retrieved by the recommended route searching unit 70 to the driving assistance control apparatus or the automatic driving control apparatus (step S610).

The driving assistance control apparatus or the automatic driving control apparatus may execute the driving assistance control or the automatic driving control, on the basis of the recommended route information received from the output unit 80.

The display 90 may display the recommended route to be viewable by the user or occupant, on the basis of the recommended route information re-retrieved by the recommended route searching unit 70 (step S710).

For example, in the example of FIG. 6, the display 90 may display the route of route D received from the recommended route searching unit 70 to be viewable by the user or occupant.

### [Processing Performed in Route Re-Searching by Vehicle Navigation Apparatus 1]

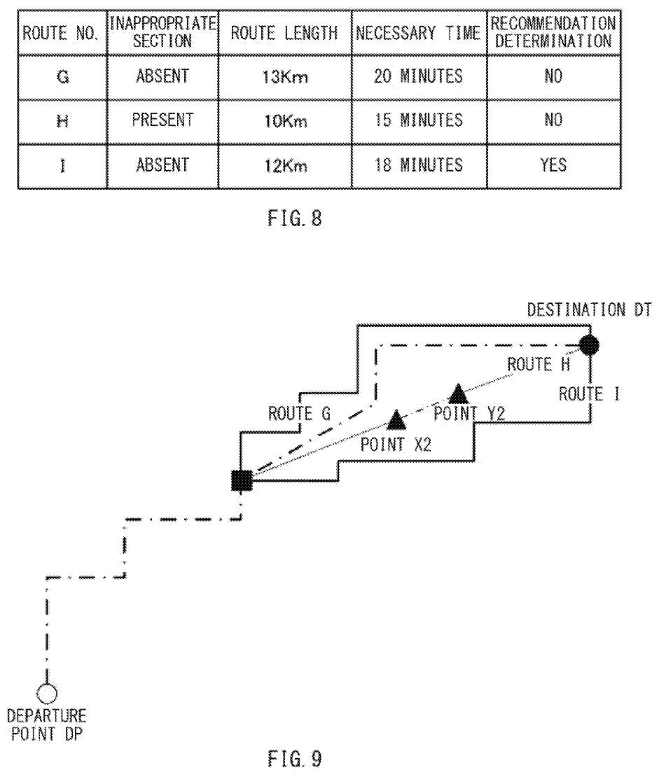

Processing performed in route re-searching by the vehicle navigation apparatus 1 according to the example embodiment will now be described with reference to FIGS. 8 to 10.

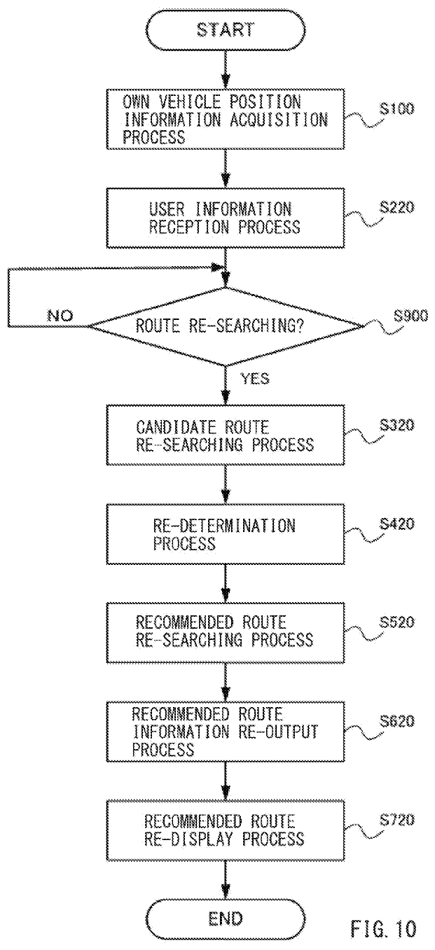

As illustrated in FIG. 10, the position information detector 20 may acquire the position information of the own vehicle (step S100). The position information of the own vehicle acquired by the position information detector 20 may be outputted to the candidate route searching unit 50.

The information receiver 30 may accept information including a re-searching request for a new route, i.e., a route re-searching request, from the user (step S220). The information accepted by the information receiver 30 may be outputted to the candidate route searching unit 50.

The candidate route searching unit 50 may determine whether a route re-searching request has been made, on the basis of the information accepted from the user via the information receiver 30 (step 900).

If the candidate route searching unit 50 determines that a route re-searching request has not been made, on the basis of the information accepted from the user via the information receiver (step S900: “NO”), the candidate route searching unit 50 may cause the processing to return to step S900 and be put on standby.

If the candidate route searching unit 50 determines that a route re-searching request has been made, on the basis of the information accepted from the user via the information receiver (step S900: “YES”), the candidate route searching unit 50 may, while keeping the destination information, re-search the navigation map information for one or more candidate routes, on the basis of the new route re-searching request accepted from the user via the information receiver 30, the position information of the own vehicle received from the position information detector 20, and other supplementary information (step S320).

For example, in the example of FIGS. 8 and 9, the candidate route searching unit 50 may re-retrieve route G, route H, and route I as the candidate routes.

The candidate route information thus re-retrieved by the candidate route searching unit 50 may be outputted to the determination unit 60 to be described later.

Regarding the candidate routes re-retrieved by the candidate route searching unit 50, the determination unit 60 may re-determine the effectiveness of the driving assistance control or the automatic driving control, on the basis of the high-precision map information stored in the second map storage 40 (step S420).

For example, in the example of FIGS. 8 and 9, the determination unit 60 may determine whether the candidate routes (route G, route H, and route I) re-retrieved by the candidate route searching unit 50 are able to secure the effectiveness of the driving assistance control or the automatic driving control, on the basis of the high-precision map information stored in the second map storage 40.

Route H includes, in a section from point X2 to point Y2, a section inappropriate for the driving assistance control or the automatic driving control. The determination unit 60 may therefore determine that the effectiveness of the driving assistance control or the automatic driving control is not securable.

In contrast, route G and route I do not include a section that inhibits the effectiveness of the driving assistance control or the automatic driving control. The determination unit 60 may therefore determine that the effectiveness of the driving assistance control or the automatic driving control is securable.

The determination unit 60 may output a determination result as illustrated in FIG. 8 to the recommended route searching unit 70.

The recommended route searching unit 70 may re-search through the candidate routes re-retrieved by the candidate route searching unit 50 for a recommended route, on the basis of the determination result obtained by the determination unit 60 (step S520).

For example, in the example of FIGS. 8 and 9, the recommended route searching unit 70 may exclude route H from the recommended route, on the basis of the determination result obtained by the determination unit 60.

In contrast, for route G or route I, the recommended route searching unit 70 may, for example, refer to the route length and the necessary time of each route, and retrieve route I with a shorter route length and a shorter necessary time as the recommended route.

The recommended route searching unit 70 may output the recommended route information to the output unit 80 and the display 90.

The output unit 80 may output the recommended route information re-retrieved by the recommended route searching unit 70 to the driving assistance control apparatus or the automatic driving control apparatus (step S620).

The driving assistance control apparatus or the automatic driving control apparatus may execute the driving assistance control or the automatic driving control, on the basis of the recommended route information received from the output unit 80.

The display 90 may display the recommended route to be viewable by the user or occupant, on the basis of the recommended route information re-retrieved by the recommended route searching unit 70 (step S720).

For example, in the example of FIG. 9, the display 90 may display the route of route I received from the recommended route searching unit 70 to be viewable by the user or occupant.

### [Working and Effects]

As described above, the determination unit 60 of the vehicle navigation apparatus 1 according to the example embodiment determines, regarding the candidate routes retrieved by the candidate route searching unit 50 on the basis of the navigation map information, the effectiveness of the driving assistance control or the automatic driving control, on the basis of the high-precision map information stored in the second map storage 40.

In other words, instead of determining the candidate routes and the recommended route on the basis of only the route length and the necessary time, for example, as in an existing technique, the candidate routes and the recommended route are determined by taking into consideration the effectiveness of the driving assistance control or the automatic driving control.

As a result, regarding the candidate routes retrieved by the candidate route searching unit 50 on the basis of the navigation map information, a route satisfying the effectiveness of the driving assistance control or the automatic driving control is existent in both the navigation map and the high-precision map.

This makes it possible to reduce a feeling of strangeness or anxiety of the user, by achieving both route display based on the navigation map information and the driving assistance control or the automatic driving control based on the high-precision map.

The recommended route searching unit 70 of the vehicle navigation apparatus 1 according to the example embodiment searches through the candidate routes retrieved by the candidate route searching unit 50 for a recommended route, on the basis of the determination result obtained by the determination unit 60.

For example, the recommended route searching unit 70 may exclude a route not satisfying the effectiveness of the driving assistance control or the automatic driving control from the recommended route, on the basis of the determination result obtained by the determination unit 60, and retrieve a route satisfying the effectiveness of the driving assistance control or the automatic driving control as the recommended route in consideration of, for example, the route length and the necessary time.

This makes it possible to reduce a feeling of strangeness or anxiety of the user, by achieving both the route display based on the navigation map information and the driving assistance control or the automatic driving control based on the high-precision map, and to improve convenience for the user.

In addition, in the vehicle navigation apparatus 1 according to the example embodiment, in a case where a destination change request from the user is made, the candidate route searching unit 50 may re-search the navigation map information for one or more candidate routes, in response to the destination change request from the user. The determination unit 60 may determine, regarding the candidate routes re-retrieved by the candidate route searching unit 50, the effectiveness of the driving assistance control or the automatic driving control. The recommended route searching unit 70 may re-search through the candidate routes for a recommended route, on the basis of the determination result obtained by the determination unit 60.

Thus, even in the case where a destination change request from the user is made, it is possible to reduce a feeling of strangeness or anxiety of the user, by achieving both the route display based on the navigation map information and the driving assistance control or the automatic driving control based on the high-precision map.

In addition, in the vehicle navigation apparatus 1 according to the example embodiment, in a case where a route re-searching request from the user is made, the candidate route searching unit 50 may re-search the navigation map information for one or more candidate routes, on the basis of the route re-searching request from the user. The determination unit 60 may determine, regarding the candidate routes re-retrieved by the candidate route searching unit 50, the effectiveness of the driving assistance control or the automatic driving control. The recommended route searching unit 70 may re-search through the candidate routes for a recommended route, on the basis of the determination result obtained by the determination unit 60.

Thus, even in the case where a route re-searching request from the user is made, it is possible to reduce a feeling of strangeness or anxiety of the user, by achieving both the route display based on the navigation map information and the driving assistance control or the automatic driving control based on the high-precision map.

### Second Example Embodiment

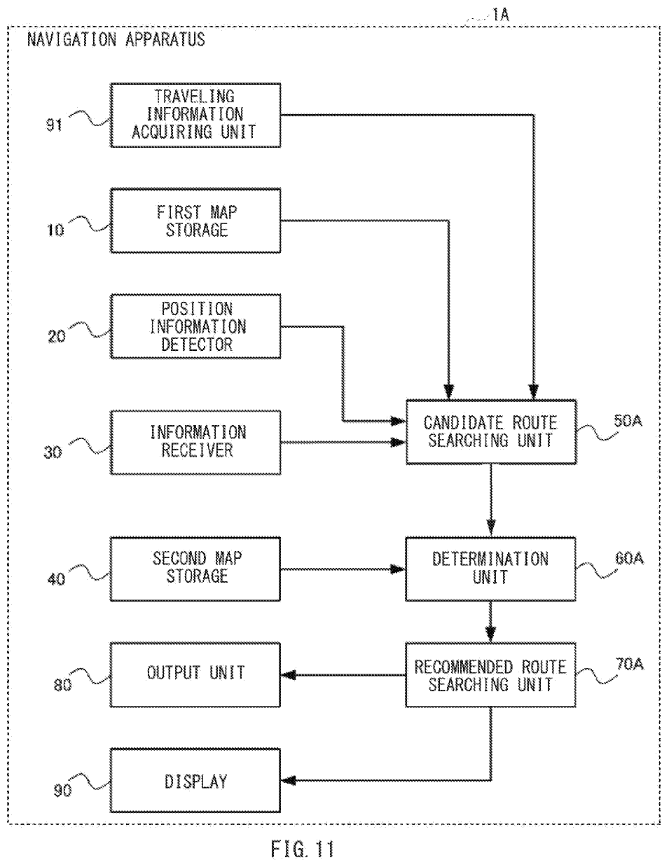

A vehicle navigation apparatus 1A according to a second example embodiment will now be described with reference to FIGS. 11 to 14.

### [Configuration of Vehicle Navigation Apparatus 1A]

As illustrated in FIG. 11, the vehicle navigation apparatus 1A according to the example embodiment may include the first map storage 10, the position information detector 20, the information receiver 30, the second map storage 40, a candidate route searching unit 50A, a determination unit 60A, a recommended route searching unit 70A, the output unit 80, the display 90, and a traveling information acquiring unit 91.

Note that components having configurations similar to those of the components in the first example embodiment are denoted with the same reference numerals without redundant description.

The candidate route searching unit 50A may execute re-searching for one or more candidate routes based on the navigation map information.

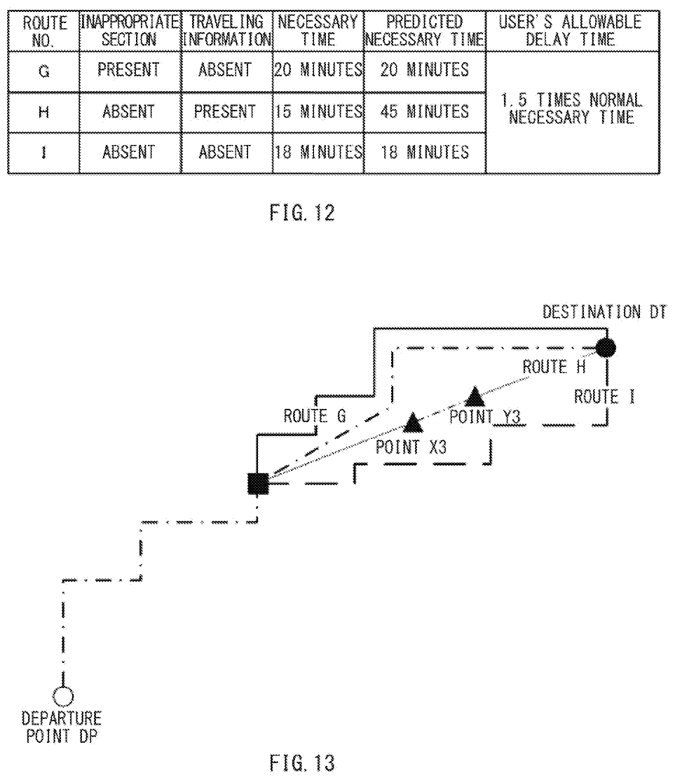

In one example, in the example of FIG. 12, the candidate route searching unit 50A may execute the re-searching for candidate routes based on the navigation map information, in a case where a route currently traveled is route H, and a section from point X3 to point Y3 of route H is a section that has an issue in traveling, including a traffic congestion section or a non-travelable section.

In the example of FIG. 12, the candidate route searching unit 50A may re-retrieve route G and route I as the candidate routes, and output the information illustrated in FIG. 12 to the determination unit 60A.

The determination unit 60A may determine, regarding the candidate routes re-retrieved by the candidate route searching unit 50A, the effectiveness of the driving assistance control or the automatic driving control.

In the example of FIG. 12, none of the candidate routes, route G and route I, re-retrieved by the candidate route searching unit 50A involve a matter inhibiting the effectiveness of the driving assistance control or the automatic driving control. The determination unit 60A may therefore output the information regarding route G and route I illustrated in FIG. 12 to the recommended route searching unit 70A.

The recommended route searching unit 70A may search through the candidate routes based on the re-searching retrieved by the candidate route searching unit 50A for a recommended route based on the re-searching, on the basis of a determination result obtained by the determination unit 60A.

In the example of FIG. 12, for route G or route I received from the determination unit 60A, the recommended route searching unit 70A may, for example, refer to the necessary time thereof, and retrieve route I with a shorter necessary time as the recommended route based on the re-searching.

The recommended route searching unit 70A may output the recommended route information to the output unit 80 and the display 90.

The traveling information acquiring unit 91 may acquire traveling information of the current recommended route.

The traveling information may refer to, for example, information regarding traffic congestion in the recommended route, or information regarding a non-travelable section. The information regarding the traffic congestion may be, for example, a traffic congestion section, a traffic congestion distance, and a predicted time until the traffic congestion is resolved. The information regarding the non-travelable section may be, for example, a road closure section, a predicted time until road closure is lifted, an accident occurrence section, and a predicted time until accident handling is completed.

The traveling information of the current recommended route acquired by the traveling information acquiring unit 91 may be outputted to, for example, the candidate route searching unit 50A.

### [Processing Performed by Vehicle Navigation Apparatus 1A]

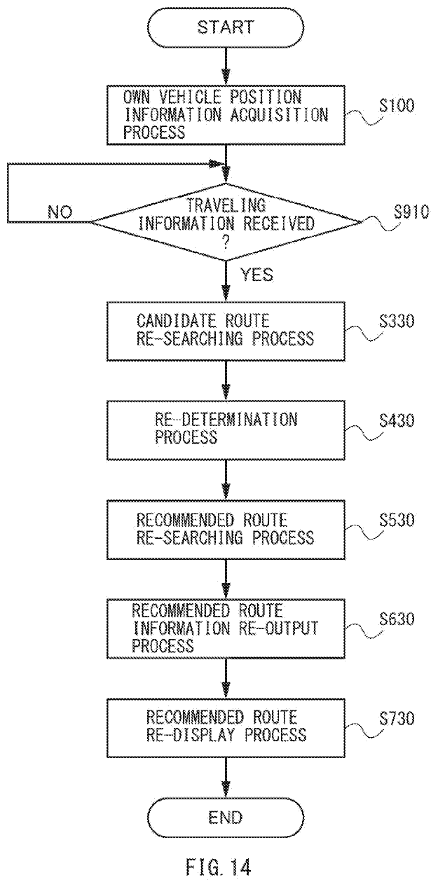

Processing performed by the vehicle navigation apparatus 1A according to the example embodiment will now be described with reference to FIG. 14.

As illustrated in FIG. 14, the position information detector 20 may acquire the position information of the own vehicle (step S100). The position information of the own vehicle acquired by the position information detector 20 may be outputted to the candidate route searching unit 50A.

The candidate route searching unit 50A may determine whether traveling information has been received from the traveling information acquiring unit 91 (step 910).

If the candidate route searching unit 50A determines that traveling information has not been received from the traveling information acquiring unit 91 (step S910: “NO”), the candidate route searching unit 50A may cause the processing to return to step S910 and be put on standby.

If the candidate route searching unit 50A determines that traveling information has been received from the traveling information acquiring unit 91 (step S910: “YES”), the candidate route searching unit 50A may cause the processing to move on to a process of re-searching the navigation map information for one or more candidate routes (step S330).

For example, in the example of FIGS. 12 and 13, the candidate route searching unit 50A may re-retrieve route G and route I as the candidate routes.

The candidate route information thus re-retrieved by the candidate route searching unit 50A may be outputted to the determination unit 60A to be described later.

Regarding the candidate routes re-retrieved by the candidate route searching unit 50A, the determination unit 60A may re-determine the effectiveness of the driving assistance control or the automatic driving control, on the basis of the high-precision map information stored in the second map storage 40 (step S430).

For example, in the example of FIGS. 12 and 13, the determination unit 60A may determine whether the candidate routes (route G and route I) re-retrieved by the candidate route searching unit 50A are able to secure the effectiveness of the driving assistance control or the automatic driving control, on the basis of the high-precision map information stored in the second map storage 40.

Route G and route I do not include a section that inhibits the effectiveness of the driving assistance control or the automatic driving control. The determination unit 60A may therefore determine that the effectiveness of the driving assistance control or the automatic driving control is securable.

The determination unit 60A may output a determination result as illustrated in FIG. 12 to the recommended route searching unit 70A.

The recommended route searching unit 70A may re-search through the candidate routes re-retrieved by the candidate route searching unit 50A for a recommended route, on the basis of the determination result obtained by the determination unit 60A (step S530).

In the example of FIGS. 12 and 13, for route G or route I, the recommended route searching unit 70A may, for example, refer to the necessary time of each route, and retrieve route I with a shorter necessary time as the recommended route.

The recommended route searching unit 70A may output the recommended route information to the output unit 80 and the display 90.

The output unit 80 may output the recommended route information re-retrieved by the recommended route searching unit 70A to the driving assistance control apparatus or the automatic driving control apparatus (step S630).

The driving assistance control apparatus or the automatic driving control apparatus may execute the driving assistance control or the automatic driving control, on the basis of the recommended route information received from the output unit 80.

The display 90 may display the recommended route to be viewable by the user or occupant, on the basis of the recommended route information re-retrieved by the recommended route searching unit 70A (step S730).

For example, in the example of FIG. 13, the display 90 may display the route of route I received from the recommended route searching unit 70A to be viewable by the user or occupant.

### [Working and Effects]

As described above, in the vehicle navigation apparatus 1A according to the example embodiment, in a case where a section that has an issue in traveling, including a traffic congestion section or a non-travelable section, occurs in the recommended route being traveled, the candidate route searching unit 50A may re-search the navigation map information for one or more candidate routes. The determination unit 60A may determine, regarding the re-retrieved candidate routes, the effectiveness of the driving assistance control or the automatic driving control. The recommended route searching unit 70A may re-search through the re-retrieved candidate routes for a recommended route, on the basis of the determination result obtained by the determination unit 60A.

Thus, even in the case where a section that has an issue in traveling, including a traffic congestion section or a non-travelable section, occurs in the recommended route being traveled, it is possible to reduce a feeling of strangeness or anxiety of the user, by achieving both the route display based on the navigation map information and the driving assistance control or the automatic driving control based on the high-precision map.

### Modification Examples

The second example embodiment describes that, in the vehicle navigation apparatus 1A, in a case where a section that has an issue in traveling, including a traffic congestion section or a non-travelable section, occurs in the recommended route being traveled, the candidate route searching unit 50A may re-search the navigation map information for one or more candidate routes. The determination unit 60A may determine, regarding the re-retrieved candidate routes, the effectiveness of the driving assistance control or the automatic driving control. The recommended route searching unit 70A may re-search through the re-retrieved candidate routes for a recommended route, on the basis of the determination result obtained by the determination unit 60A.

Alternatively, even if a section that has an issue in traveling, including a traffic congestion section or a non-travelable section, is present in a traveling route, and time it takes until the concern is resolved results in a delay, with respect to a normal necessary time, in time before arrival at the destination, the candidate route searching unit 50A may refrain from executing the re-searching for candidate routes based on the navigation map information, in a case where predicted delay time is shorter than delay time allowable by the user.

In this manner, even in a case where a section that has an issue in traveling, including a traffic congestion section or a non-travelable section, occurs in the recommended route being traveled, it is possible to reduce a feeling of strangeness or anxiety of the user, by achieving both the route display based on the navigation map information and the driving assistance control or the automatic driving control based on the high-precision map. Moreover, even if the vehicle keeps traveling the original recommended route and a delay occurs in the time before arrival at the destination, convenience for the user is not impaired, as long as the delay is allowable by the user.

Note that the vehicle navigation apparatus 1 or 1A according to any of the example embodiments of the disclosure is implemented by storing the processing to be performed by the determination unit 60 or 60A in a recording medium readable by a computer system, causing the determination unit 60 or 60A to read a program stored in the recording medium, and executing the program.

The term “computer system” used herein may encompass hardware including operating systems (OS) and peripheral devices.

In a case where the computer system is a world wide web (www) system, the term “computer system” used herein shall encompass a website providing environment or a display environment. Additionally, the program stored in, for example, the storage device of the computer system may be transmitted to another computer system via a transmission medium or a transmission wave of the transmission medium. The transmission medium transmitting the program may refer to a medium having a function of transmitting information, including a network such as the Internet (a communication network) and a communication line such as a phone line.

Further, the program described above may be a program for implementing part of the processing described above. Alternatively, the program described above may be a so-called differential file or differential program that implements the processing described above when being combined with a program having been stored in the computer system.

Although some embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, the foregoing example embodiments describe, as an example, the vehicle navigation apparatus 1 or 1A that centrally implements processing on the vehicle side. However, a system may be configured in which processing implementable by the determination unit 60 or 60A and the second map storage 40 are separated from the vehicle navigation apparatus 1 or 1A and implemented by a server.

Configuring such a system makes it unnecessary for equipment on the vehicle side to download the high-precision map, which enables high-speed processing by simple control.

Each of the candidate route searching unit 50, the determination unit 60, the recommended route searching unit 70, the output unit 80, and the traveling information acquiring unit 91 illustrated in FIGS. 1 and 11 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of each of the candidate route searching unit 50, the determination unit 60, the recommended route searching unit 70, the output unit 80, and the traveling information acquiring unit 91. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and an SRAM, and the nonvolatile memory may include a ROM and an NVRAM. The ASIC is an integrated circuit (IC) customized to perform, and the FPGA is an integrated circuit designed to be configured after manufacturing in order to perform, all or a part of the functions of each of the candidate route searching unit 50, the determination unit 60, the recommended route searching unit 70, the output unit 80, and the traveling information acquiring unit 91 illustrated in FIGS. 1 and 11.

1. A vehicle navigation apparatus to be applied to a vehicle, the vehicle navigation apparatus comprising:
a first map storage configured to store navigation map information;
a second map storage configured to store high-precision map information;
a position information detector configured to acquire position information of the vehicle;
an information receiver configured to accept information comprising destination information from a user of the vehicle;
a candidate route searching unit configured to perform searching of the navigation map information for one or more candidate routes, on a basis of the destination information and the position information of the vehicle;
a determination unit configured to make a determination as to, regarding the one or more candidate routes retrieved by the searching, effectiveness of driving assistance control or automatic driving control on a basis of the high-precision map information;
a recommended route searching unit configured to perform searching through the one or more candidate routes for a recommended route, on a basis of a result of the determination made by the determination unit;
an output unit configured to output information on the recommended route to a driving assistance control apparatus or an automatic driving control apparatus; and
a display configured to display the recommended route, wherein
the determination unit is configured to determine a route that is unlikely to cause abnormality in the driving assistance control or the automatic driving control as a route with the effectiveness.

2. The vehicle navigation apparatus according to claim 1, wherein, in a case where, before the vehicle arrives at a destination, the information receiver accepts a change request for the destination and new destination information from the user,
the candidate route searching unit is configured to perform re-searching of the navigation map information for one or more candidate routes, on a basis of the new destination information,
the determination unit is configured to make a re-determination as to, regarding the one or more candidate routes retrieved by the re-searching, the effectiveness of the driving assistance control or the automatic driving control, and
the recommended route searching unit is configured to perform re-searching through the one or more candidate routes for a recommended route, on a basis of a result of the re-determination made by the determination unit.

3. The vehicle navigation apparatus according to claim 1, wherein, in a case where, before the vehicle arrives at a destination, the information receiver accepts a re-searching request for a route to the destination from the user,
the candidate route searching unit is configured to perform re-searching of the navigation map information for one or more candidate routes, on a basis of the re-searching request,
the determination unit is configured to make a re-determination as to, regarding the one or more candidate routes retrieved by the re-searching, the effectiveness of the driving assistance control or the automatic driving control, and
the recommended route searching unit is configured to perform re-searching through the one or more candidate routes for a recommended route, on a basis of a result of the re-determination made by the determination unit.

4. The vehicle navigation apparatus according to claim 1, further comprising a traveling information acquiring unit configured to acquire traveling information of the recommended route, wherein,
in a case where the traveling information indicates occurrence, in the recommended route, of a section that has an issue in traveling and comprises a traffic congestion section or a non-travelable section,
the candidate route searching unit is configured to perform re-searching of the navigation map information for one or more candidate routes,
the determination unit is configured to make a re-determination as to, regarding the one or more candidate routes retrieved by the re-searching, the effectiveness of the driving assistance control or the automatic driving control, and
the recommended route searching unit is configured to perform re-searching through the one or more candidate routes for a recommended route, on a basis of a result of the re-determination made by the determination unit.

5. A vehicle navigation apparatus to be applied to a vehicle, the vehicle navigation apparatus comprising:
a first map storage configured to store navigation map information;
a second map storage configured to store high-precision map information;
a position information detector configured to acquire position information of the vehicle;
an information receiver configured to accept information comprising destination information from a user of the vehicle;
circuitry configured to
perform searching of the navigation map information for one or more candidate routes, on a basis of the destination information and the position information of the vehicle,
make a determination as to, regarding the one or more candidate routes retrieved by the searching, effectiveness of driving assistance control or automatic driving control on a basis of the high-precision map information, and determine a route that is unlikely to cause abnormality in the driving assistance control or the automatic driving control as a route with the effectiveness,
perform searching through the one or more candidate routes for a recommended route, on a basis of a result of the determination as to the effectiveness, and
output information on the recommended route to a driving assistance control apparatus or an automatic driving control apparatus; and
a display configured to display the recommended route, wherein
the circuitry unit is configured to determine a route that is unlikely to cause abnormality in the driving assistance control or the automatic driving control as a route with the effectiveness.
